(19) United States
(12) Patent Application Publication
(10) Pub. No.: US 2026/0202974 A1
(43) Pub. Date: Jul. 16, 2026

(54) MEMORY SYSTEM AND METHOD OF OPERATING THE SAME

(71) Applicant: SK hynix Inc., Icheon-si Gyeonggi-do (KR)

(72) Inventors: Jong Wook KIM, Icheon-si Gyeonggi-do (KR); Jae Sung SIM, Icheon-si Gyeonggi-do (KR); Hyun Young SHIM, Icheon-si Gyeonggi-do (KR); Chi Wook AN, Icheon-si Gyeonggi-do (KR)

(73) Assignee: SK hynix Inc., Icheon-si Gyeonggi-do (KR)

(21) Appl. No.: 19/449,100

(22) Filed: Jan. 14, 2026

(30) Foreign Application Priority Data
Jan. 15, 2025 (KR) 10-2025-0005979

(51) Int. Cl. G06F 3/06

(52) U.S. Cl. CPC G06F 3/0619; G06F 3/0659; G06F 3/0679

(57) ABSTRACT

For a memory system and a method of operating the same, when a sudden power-off (SPO) event occurs after multi-bit data are foggy-programmed into at least one open memory block included in a non-volatile memory device included in the memory system, the memory system may operate to convert backup-target multi-bit data stored in a plurality of backup-target memory cells included in the at least one open memory block into 1-bit backup data based on corresponding threshold voltage distribution information, group at least two pieces of the 1-bit backup data to generate at least one piece of multi-bit backup data, and store the at least one piece of multi-bit backup data in the non-volatile memory device.

### CROSS-REFERENCES TO RELATED APPLICATION

The present application claims priority under 35 U.S.C. § 119(a) to Korean patent application number 10-2025-0005979, filed on January 15, 2025, in the Korean Intellectual Property Office, which application is incorporated herein by reference in its entirety.

### BACKGROUND

### 1. Technical Field

An embodiment relates to a semiconductor device, and more particularly, to a memory system and a method of operating the same.

### 2. Related Art

As an example of non-volatile memory, flash memory may include a plurality of memory cells having different threshold voltages depending on their program states. In a single-level cell (SLC) mode, a memory cell may be programmed to have a threshold voltage corresponding to either an erase state or a program state. Meanwhile, in a multi-level cell (MLC) mode, a memory cell may be programmed to have a threshold voltage corresponding to one of an erase state and multiple program states. Here, the MLC mode may be a mode in which two or more bits of multi-bit data are stored in a single memory cell.

When a sudden power-off (SPO) event occurs while programming data into non-volatile memory, data backup may be required for the memory cells being programmed. At this time, data programmed in the MLC mode may be multi-bit data, and during the data backup, all the multi-bit data is stored in the SLC mode. In other words, the data backup of a memory cell programmed with two or more bits of multi-bit data may require two or more memory cells. Accordingly, the number of memory cells operating in the SLC mode required for data backup may increase exponentially with the number of bits of the multi-bit data, and as the amount of data to be backed up increases, the required capacity of the auxiliary power source used for the data backup also increases.

### SUMMARY

An embodiment is directed to a memory system that may be capable of efficiently backing up multi-bit data when a sudden power-off (SPO) event occurs during a program operation of the multi-bit data.

An embodiment is also directed to a method of operating the above-mentioned memory system.

According to an embodiment, a method of operating a memory system includes foggy-programming multi-bit data into at least one open memory block included in a non-volatile memory device. The method also includes converting backup-target multi-bit data stored in a plurality of backup-target memory cells included in the at least one open memory block into 1-bit backup data based on corresponding threshold voltage distribution information, when a sudden power-off (SPO) event occurs. The method further includes grouping at least two pieces of the 1-bit backup data to generate at least one piece of multi-bit backup data and storing the at least one piece of the multi-bit backup data in the non-volatile memory device.

According to an embodiment, a memory system includes a non-volatile memory device including at least one open memory block. The memory system also includes a memory controller configured to foggy-program multi-bit data into the at least one open memory block in response to a request from a host. The memory controller is also configured to convert backup-target multi-bit data stored in a plurality of backup-target memory cells included in the at least one open memory block into 1-bit backup data based on corresponding threshold voltage distribution information when a sudden power-off (SPO) event occurs, group at least two pieces of the 1-bit backup data to generate at least one piece of multi-bit backup data. The memory controller is further configured to store the at least one piece of multi-bit backup data in the non-volatile memory device.

According to an embodiment, when an SPO event occurs during programming of the multi-bit data, the multi-bit data stored in each of the backup-target memory cells may be converted into the 1-bit backup data based on the corresponding threshold voltage distribution information and then stored, thereby reducing the memory capacity and power consumption required for backup.

In addition, according to an embodiment, the plurality of 1-bit backup data corresponding to the backup-target memory cells may be grouped in units of at least two to generate and store a plurality of multi-bit backup data, thereby minimizing the memory capacity and power consumption required for backup.

### BRIEF DESCRIPTION OF THE DRAWINGS

The above and another aspects, features, and advantages of the subject matter of the present disclosure will be more easily understood from the following detailed description taken in conjunction with the accompanying drawings, in which:

FIG. 1 is a block diagram illustrating a memory system in accordance with an embodiment;

FIG. 2 is a set of diagrams illustrating threshold voltage distributions of non-volatile memory in accordance with an embodiment;

FIG. 3 is a block diagram illustrating the memory controller of FIG. 1 in accordance with an embodiment;

FIG. 4 is a block diagram illustrating the non-volatile memory of FIG. 1 in accordance with an embodiment;

FIG. 5 is a circuit diagram illustrating an implementation of a memory block of FIG. 4 in accordance with an embodiment;

FIG. 6 is a conceptual diagram illustrating a first open memory block in which an SPO event occurs during a fine-program operation and a second open memory block in which an SPO event occurs during a foggy-program operation in the memory system in accordance with an embodiment;

FIG. 7 is a conceptual diagram illustrating various grouping schemes for a plurality of 1-bit backup data respectively corresponding to a plurality of backup-target memory cells in a plurality of open memory blocks in accordance with an embodiment; and

FIG. 8 is a flowchart illustrating a method of operating a memory system in accordance with an embodiment.

### DETAILED DESCRIPTION

Advantages and features for embodiments of the present teachings and methods for achieving them will become apparent from the following detailed description, which should be read in conjunction with the accompanying drawings. However, the present teachings are not limited to the embodiments disclosed below, and may be embodied in various different forms. Embodiments are provided to make the present disclosure accessible to those skilled in the art to which the present teachings pertain. The present teachings defined only by the scope of the claims.

Sizes and relative sizes of layers and regions in the drawings may be exaggerated for clarity of explanation. Throughout the specification, like reference numerals refer to like elements.

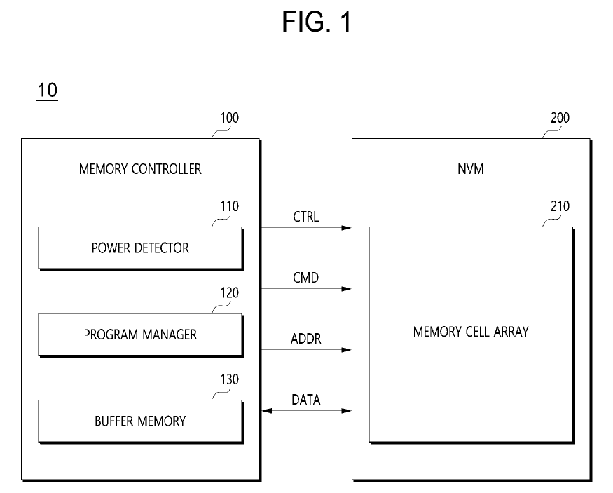

FIG. 1 is a block diagram illustrating a memory system in accordance with an embodiment.

Referring to FIG. 1, a memory system 10 may include a memory controller 100 and a non-volatile memory (NVM) device 200. For example, the memory system 10 may be implemented as a storage device such as a solid-state drive (SSD).

The memory controller 100 may control overall operations of the non-volatile memory device 200. For example, the memory controller 100 may provide control signals CTRL, commands CMD, and addresses ADDR to the non-volatile memory device 200 to control operations of the non-volatile memory device 200. Specifically, in response to a request received from an external host, the memory controller 100 may control the non-volatile memory device 200 to program data DATA into the non-volatile memory device 200 or to read data DATA from the non-volatile memory device 200.

The memory controller 100 may include a power detector 110, a program manager 120, and buffer memory 130.

The power detector 110 may detect a power state of the memory controller 100. For example, the power detector 110 may detect an unexpected sudden power-off (SPO) event from a voltage supplied to the memory controller 100. Further, the power detector 110 may also detect power recovery after the SPO event. The power detector 110 may determine that an SPO event has occurred when the voltage supplied to the memory controller 100 falls below a threshold voltage. The power detector 110 may determine that power has been recovered when the voltage supplied to the memory controller 100 exceeds the threshold voltage.

The program manager 120 may manage programming operations of the non-volatile memory device 200. For example, the program manager 120 may provide the control signals CTRL, the commands CMD, the addresses ADDR, and the data DATA to the non-volatile memory device 200 according to a predetermined schedule for programming operations. In an embodiment, when an SPO event occurs during a programming operation in the non-volatile memory device 200, the program manager 120 may provide the control signals CTRL, the commands CMD, the addresses ADDR, and the data DATA to the non-volatile memory device 200 to back-up the data being programmed.

The buffer memory 130 may temporarily store data. For example, the buffer memory 130 may temporarily store data to be programmed into the non-volatile memory device 200 or data read from the non-volatile memory device 200. In an embodiment, the buffer memory 130 may be dynamic random-access memory (DRAM) or static random-access memory (SRAM), but is not limited thereto.

The non-volatile memory device 200 may operate under the control of the memory controller 100. For example, the non-volatile memory device 200 may read and provide previously stored data to the memory controller 100. Further, the non-volatile memory device 200 may store data provided by the memory controller 100.

The non-volatile memory device 200 may include a memory cell array 210. The memory cell array 210 may include a plurality of memory cells. The plurality of memory cells may be flash memory cells, but they are not limited thereto. In other embodiments, the plurality of memory cells may be resistive random-access memory (RRAM) cells, ferroelectric random-access memory (FRAM) cells, phase change random-access memory (PRAM) cells, thyristor random-access memory (TRAM) cells, or magnetic random-access memory (MRAM) cells. In example embodiments, for ease of explanation, it is assumed that the memory cells are NAND flash memory cells.

Each of the plurality of memory cells included in the memory cell array 210 may store N bits of data (where N is a positive integer). When N is 2 or more, the memory cell may be referred to as a multi-level cell (MLC), and N-bit data may be referred to as multi-bit data. For example, when N = 3, the memory cell may be referred to as a triple-level cell (TLC), and when N = 4, the memory cell may be referred to as a quadruple-level cell (QLC).

In example embodiments, for convenience of explanation, all cases where N is 2 or more (e.g., 2, 3, and 4) will be collectively referred to as “multi-bit data.”

In an embodiment, when an SPO event occurs during a program operation for multi-bit data, the memory system 10 may back up an amount of data smaller than the amount of the multi-bit data itself. When power is restored, the memory system 10 may reconstruct the multi-bit data based on the backed-up data. Accordingly, the capacity of the auxiliary power source used for backup and the memory capacity required for backup may be reduced. Hereinafter, example embodiments for efficiently backing up multi-bit data when the SPO event occurs during a program operation will be described in detail.

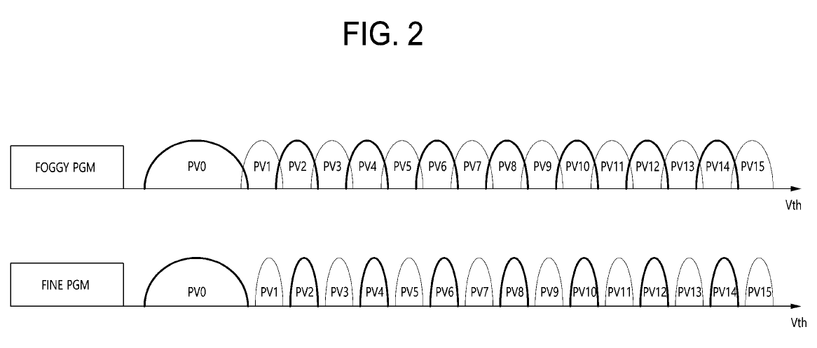

FIG. 2 is a diagram illustrating threshold voltage distributions of a non-volatile memory in accordance with an embodiment.

Referring to FIG. 2, in response to a program request from a host, the memory controller 100 of the memory system 10 may perform a foggy-program operation to program multi-bit data into memory cells of the non-volatile memory device 200. For example, the foggy program may also be referred to as a pre-program or a coarse program.

In an embodiment, when the multi-bit data is 4-bit data, as shown in FIG. 2, a foggy-programmed memory cell may have a threshold voltage corresponding to one of sixteen threshold voltage distributions PV0 through PV15. The sixteen threshold voltage distributions respectively may correspond to sixteen possible values of the 4 bits of data. For example, the foggy-programmed memory cell may correspond to one of the sixteen threshold voltage distributions depending on levels (or values) of the 4 bits of data.

In this case, the threshold voltages of the memory cells may fluctuate due to capacitive coupling between adjacent memory cells, which may broaden the width of each threshold voltage distribution. As a result, portions of adjacent threshold voltage distributions may overlap with each other.

The memory controller 100 may perform fine-program (Fine PGM) operations on the foggy-programmed 4 bits of data. The fine-program may also be referred to as a re-program.

As shown in FIG. 2, by performing the fine-program, the widths of the respective threshold voltage distributions of the memory cells are narrowed, thereby completing the program operation for the multi-bit data (i.e., 4-bit data). Because the threshold voltage increase of a memory cell during fine-program is smaller than that during foggy-program, the memory cells may be less affected by capacitive coupling between adjacent cells. Accordingly, the memory cells after completion of the fine-program may have narrower threshold voltage distributions, and the overlap regions between adjacent threshold voltage distributions may be reduced.

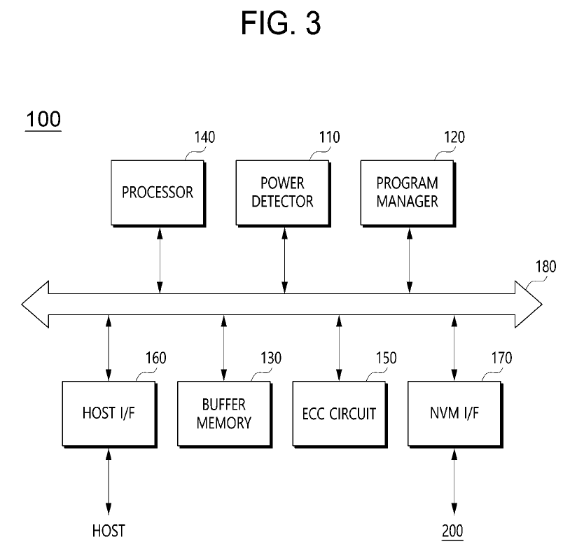

FIG. 3 is a block diagram illustrating the memory controller of FIG. 1.

Referring to FIG. 3, the memory controller 100 may include a power detector 110, a program manager 120, buffer memory 130, a processor 140, an error correction code (ECC) circuit 150, a host interface 160, a non-volatile memory interface 170, and a bus 180. In the following description, repeated content already explained with reference to FIG. 1 will be omitted for simplicity.

The power detector 110 may detect a voltage supplied to the memory controller 100 to determine whether an SPO event has occurred or power has been recovered after the SPO event. For example, the power detector 110 may be implemented as a voltage sensor.

The program manager 120 may manage program operations for multi-bit data. For example, as described with reference to FIG. 2, the program manager 120 may generate control signals CTRL, commands CMD, and addresses ADDR to perform program operations for multi-bit data through the foggy-program and the fine-program operations. In an embodiment, when an SPO event occurs during a program operation for multi-bit data, the program manager 120 may generate the control signals CTRL, the commands CMD, and the addresses ADDR to perform backup operations for the multi-bit data.

In an embodiment, the program manager 120 may manage address information for programming multi-bit data and address information for programming backup data of the multi-bit data. The address information may be stored in the buffer memory 130 or in other memory (not shown) within the memory controller 100. When the SPO event occurs during a program operation for multi-bit data, the address information may be programmed into the non-volatile memory device 200 together with the backup data of the multi-bit data.

In an embodiment, the program manager 120 may be implemented as software or firmware such as a Flash Translation Layer (FTL). In this case, the program manager 120 may be loaded into memory within a memory controller 100 and executed by the processor 140. For example, the memory may include the buffer memory 130 or other memory (not shown) However, the present teachings are not limited thereto, and the program manager 120 may alternatively be implemented in hardware.

The buffer memory 130 may temporarily store data. For example, the data may be provided from a host, generated within the memory controller 100, or provided from the non-volatile memory device 200. For example, during a programming operation, the buffer memory 130 may temporarily store multi-bit data (e.g., 4-bit data) to be provided to the non-volatile memory device 200.

When the SPO event occurs during a foggy-program or fine-program operation, the multi-bit data stored in the buffer memory 130 may be lost. After power is restored following the SPO event, multi-bit data (e.g., foggy-programmed multi-bit data) read from the non-volatile memory device 200 may be temporarily stored in the buffer memory 130.

The processor 140 may control the overall operation of the memory controller 100. For example, the processor 140 may direct the program manager 120 to perform program operations for multi-bit data.

The error correction code (ECC) circuit 150 may correct errors in data provided by (or read from) the non-volatile memory device 200. For example, after power is restored following the SPO event, the ECC circuit 150 may correct errors in multi-bit data (e.g., foggy-programmed multi-bit data) read from the non-volatile memory device 200. When the fine-program is performed based on the error-corrected multi-bit data, the reliability of the multi-bit data programmed into the non-volatile memory device 200 may be improved.

The host interface 160 may provide a physical connection between the host and the memory controller 100. For example, the host interface 160 may support various interface schemes such as ATA (Advanced Technology Attachment), SATA (Serial ATA), e-SATA (External SATA), SCSI (Small Computer System Interface), SAS (Serial Attached SCSI), PCI (Peripheral Component Interconnection), PCI-E (PCI Express), IEEE 1394, USB (Universal Serial Bus), SD (Secure Digital) card, MMC (Multi-Media Card), eMMC (Embedded Multi-Media Card), and CF (Compact Flash) card interfaces.

The non-volatile memory interface 170 may provide a physical connection between the memory controller 100 and the non-volatile memory device 200. For example, the control signals CTRL, the commands CMD, the addresses ADDR, and the data DATA may be transmitted and received between the memory controller 100 and the non-volatile memory device 200 through the non-volatile memory interface 170.

The bus 180 may be configured to provide channels between the components of the memory controller 100.

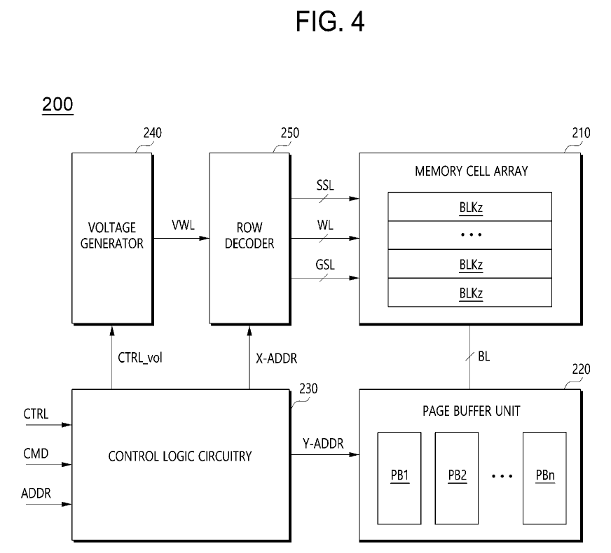

FIG. 4 is a block diagram illustrating the non-volatile memory device of FIG. 1.

Referring to FIG. 4, the non-volatile memory device 200 may include a memory cell array 210, a page buffer unit 220, control logic circuitry 230, a voltage generator 240, and a row decoder 250. Although not shown in FIG. 4, the non-volatile memory device 200 may further include a data input/output circuit or input/output interface. In addition, the non-volatile memory device 200 may further include column logic, a pre-decoder, a temperature sensor, a command decoder, and an address decoder.

The memory cell array 210 may include a plurality of memory blocks BLK1 to BLKz (where z is a positive integer). Each of the memory blocks BLK1 to BLKz may include a plurality of memory cells. The memory blocks BLK1 to BLKz may be included in a single memory plane, but the present teachings are not limited thereto.

The memory cell array 210 may be connected to the page buffer unit 220 through a plurality of bit lines BL. Further, the memory cell array 210 may be connected to the row decoder 250 through a plurality of word lines WL, a plurality of string selection lines SSL, and a plurality of ground selection lines GSL.

The memory cell array 210 may be a three-dimensional (3D) memory cell array, which may include a plurality of NAND strings. Each NAND string may include memory cells connected to word lines stacked vertically over a substrate. Alternately, the memory cell array 210 may be a two-dimensional (2D) memory cell array, which may include a plurality of NAND strings arranged along row and column directions.

The page buffer unit 220 may include a plurality of page buffers PB1 to PBn (where n is an integer of 3 or more), and the page buffers PB1 to PBn may be respectively connected to memory cells through the plurality of bit lines BL. The page buffer unit 220 may select at least 1 bit line among the bit lines BL in response to a column address Y-ADDR.

The page buffer unit 220 may operate as a write driver or a sense amplifier depending on an operation mode. For example, during a program operation, the page buffer unit 220 may apply a bit line voltage corresponding to data to be programmed to a selected bit line. During a read operation, the page buffer unit 220 may detect data stored in a memory cell by sensing the current or voltage of a selected bit line.

The control logic circuitry 230 may control overall operations within the non-volatile memory device 200. In response to the control signals CTRL, the commands CMD, and the addresses ADDR, the control logic circuitry 230 may output various control signals for programming data into the memory cell array 210, reading data from the memory cell array 210, or erasing data stored in the memory cell array 210.

For example, the control logic circuitry 230 may output voltage control signals CTRL_vol, row addresses X-ADDR, and column addresses Y-ADDR. In an embodiment, the control logic circuitry 230 may output control signals for programming multi-bit data based on the control signals CTRL, the commands CMD, and the addresses ADDR received from the memory controller 100. For example, the control logic circuitry 230 may output control signals for foggy-program and fine-program operations, for programming backup multi-bit data, or for reading foggy-programmed multi-bit data.

The voltage generator 240 may generate various types of voltages for performing program, read, and erase operations based on the voltage control signals CTRL_vol. For example, the voltage generator 240 may generate a program voltage, a read voltage, and a program verify voltage as word line voltages VWL.

In a program operation for multi-bit data, the voltage generator 240 may generate a foggy-program verify voltage for foggy-program operations and a fine-program verify voltage for fine-program operations. In this case, the foggy-program verify voltage may be lower than the fine-program verify voltage.

The row decoder 250 may select one of the plurality of word lines WL and one of the plurality of string selection lines SSL in response to a row address X-ADDR. For example, during the program operation, the row decoder 250 may apply a program voltage and a program verify voltage to a selected word line. During the read operation, the row decoder 250 may apply a read voltage to the selected word line.

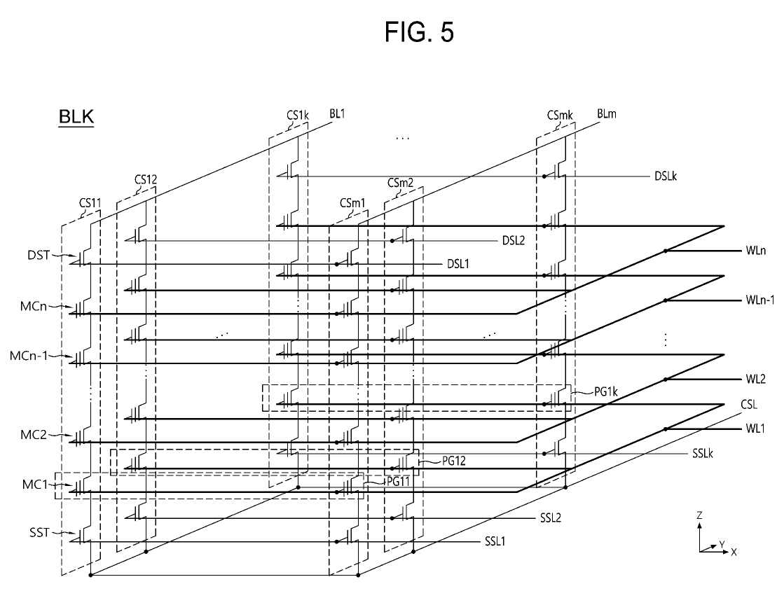

FIG. 5 is a circuit diagram illustrating an example implementation of a memory block of FIG. 4. For example, a memory block BLK included in the non-volatile memory device 200 may include memory cells arranged in a three-dimensional structure, although the present teachings are not limited thereto.

Referring to FIG. 5, the memory block BLK may have a three-dimensional vertical structure. For example, the memory block BLK may include a plurality of bit lines BL1 to BLm spaced apart in a first direction, a plurality of cell strings CS11 to CS1k through CSm1 to CSmk spaced apart in a second direction and connected to the respective bit lines BL1 to BLm, and a plurality of word lines WL1 to WLn spaced apart in a third direction. Here, the first direction may correspond to an X-axis direction, the second direction to a Y-axis direction, and the third direction to a Z-axis direction, although the present teachings are not limited thereto.

As shown in FIG. 5, because k cell strings are connected to each of the m bit lines, m × k cell strings may be arranged within the memory block (BLK). Here, n, m, and k may each be an integer of 1 or more.

Each of the plurality of cell strings CS11 to CS1k through CSm1 to CSmk may include at least one source selection transistor SST, first to n-th memory cells MC1 to MCn, and at least one drain selection transistor DST. The source selection transistor SST of each cell string may be connected between a common source line CSL and the memory cells MC1 to MCn.

The source selection transistors SST of the cell strings arranged on the same line in the X-axis direction may be connected to the same source selection line. For example, the source selection transistors SST of the plurality of first cell strings CS11 to CSm1 connected to each bit line BL1 to BLm may be connected to a first source selection line SSL1. Similarly, the source selection transistors SST of the plurality of second to k-th cell strings CS12 to CS1k through CSm2 to CSmk connected to each bit line BL1 to BLm may be connected to second to k-th source selection lines SSL2 to SSLk, respectively.

The first to n-th memory cells MC1 to MCn of each of the plurality of cell strings CS11 to CS1k through CSm1 to CSmk may be connected in series between the source selection transistor SST and the drain selection transistor DST.

The first to n-th memory cells MC1 to MCn of the plurality of cell strings CS11 to CS1k through CSm1 to CSmk may be connected to the first to n-th word lines, respectively. At this time, the memory cells connected to the same word line and arranged on the same line in the X-axis direction may be defined as a page unit.

For example, as shown in FIG. 5, first memory cells MC1 of the first cell strings CS11 to CSm1 arranged on the same line in the X-axis direction and connected to the first word line WL1 may be defined as a 1-1 page PG11. Similarly, the first memory cells MC1 of the second to k-th cell strings CS12 to CS1k through CSm2 to CSmk arranged on the same line in the X-axis direction and connected to the first word line WL1 may be defined as 1-2 to 1-k pages PG12 to PG1k, respectively. In the memory block BLK having the three-dimensional vertical structure shown in FIG. 5, a plurality of pages may be connected to one word line, although the present teachings are not limited thereto.

Each word line WL1 to WLn may have k pages connected thereto, and accordingly, the memory block BLK may include n × k pages. The number of pages per word line WL1 to WLn may vary depending on the number of cell strings connected to each bit line BL1 to BLm.

Hereinafter, foggy-program and fine-program operations for multi-bit data in the memory block BLK having a three-dimensional vertical structure shown in FIG. 5 are described as an example.

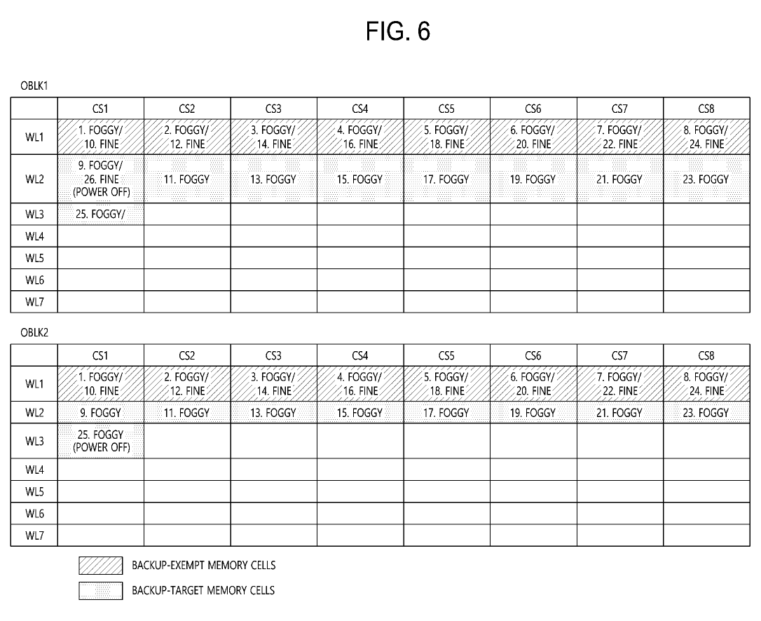

FIG. 6 is a conceptual diagram illustrating a first open memory block in which an SPO event occurs during a fine-program operation and a second open memory block in which an SPO event occurs during a foggy-program operation in a memory system in accordance with an embodiment.

Here, an open memory block may refer to a memory block allocated in response to a program request from a host among a plurality of memory blocks BLK1 to BLKz included in the non-volatile memory device 200. For example, an open memory block may be selected and allocated from among memory blocks BLK1 to BLKz that store only invalid data or from among erased memory blocks. In an embodiment, at least two or more open memory blocks may be allocated, although the present teachings are not limited thereto.

Hereinafter, embodiments of the present teachings are described with reference to an example in which multi-bit data having 4 bit values may be foggy-programmed and fine-programmed into first and second open memory blocks (OBLK1 and OBLK2), respectively.

Referring to FIGS. 5, each of the first and second open memory blocks OBLK1 and OBLK2 may include at least n × k × m memory cells. However, for convenience of explanation, FIG. 6 assumes that eight cell strings CS1 to CS8 are connected to 1 bit line (not shown), and each of the cell strings CS1 to CS8 includes seven memory cells connected to seven word lines WL1 to WL7. That is, FIG. 6 illustrates, in a table format, the memory cells located at intersections of seven word lines and eight cell strings, and 4-bit multi-bit data may be programmed into each of the memory cells included in the open memory blocks.

In an embodiment, as shown in FIG. 6, 4-bit multi-bit data may be sequentially foggy-programmed into the memory cells located at intersections of the eight cell strings CS1 to CS8 and the first word line WL1, based on the order of the cell strings (e.g., 1. Foggy through 8. Foggy). After the foggy-programming of the eight memory cells connected to the first word line WL1 and the respective cell strings is completed, multi-bit data may be foggy-programmed into the memory cell located at the intersection of the second word line WL2 and the first cell string CS1 (e.g., 9. Foggy).

Next, the multi-bit data may be fine-programmed into the memory cell located at the intersection of the first word line WL1 and the first cell string CS1 (10. Fine). For example, the memory cell may include a memory cell into which multi-bit data have been foggy-programmed.

Referring to FIG. 6, in order to fine-program multi-bit data into the eight memory cells respectively connected to the first word line WL1 and the first to eighth cell strings CS1 to CS8, a foggy-program operation of the multi-bit data for the eight memory cells connected to the next word line (e.g., the second word line WL2) may first be performed.

As shown in FIG. 6, in the first open memory block OBLK1, after the foggy-programming multi-bit data into the memory cell connected to the third word line WL3 and the first cell string CS1, the SPO event occurs during the fine-programming of the multi-bit data into the memory cell connected to the second word line WL2 and the first cell string CS1. In the second open memory block OBLK2, the SPO event may occur during the foggy-programming of the multi-bit data into the memory cell connected to the third word line WL3 and the first cell string CS1.

In this case, among the memory cells of the first open memory block OBLK1, the backup-target memory cells may include eight memory cells respectively connected to the second word line WL2 and the first to eighth cell strings CS1 to CS8, and one memory cell connected to the third word line WL3 and the first cell string CS1. Similarly, among the memory cells of the second open memory block OBLK2, the backup-target memory cells may include eight memory cells respectively connected to the second word line WL2 and the first to eighth cell strings CS1 to CS8, and one memory cell connected to the third word line WL3 and the first cell string CS1.

Here, a “backup-target memory cell” refers to a memory cell in which a fine-program operation is to be performed after power is restored following the SPO event.

In addition, among the memory cells of the first and second open memory blocks OBLK1 and OBLK2, backup-exempt memory cells may include the eight memory cells respectively connected to the first word line WL1 and the first to eighth cell strings CS1 to CS8. That is, the memory cells into which multi-bit data have been fine-programmed and in which the multi-bit data have been stably stored need not be backed up when the SPO event occurs.

Referring again to FIG. 6, there may be nine backup-target memory cells for the first open memory block OBLK1 and nine backup-target memory cells for the second open memory block OBLK2. As described above, 4-bit multi-bit data may be programmed into each memory cell. For example, one memory cell may store values of the 4-bit multi-bit data corresponding to one of the sixteen threshold voltage distributions PV0 through PV15 (see FIG. 2).

In general, when an SPO event occurs during a program operation for multi-bit data, the multi-bit data may be divided into single-bit data and backed up to increase backup speed. For example, backing up 4-bit multi-bit data typically involves storing each bit of the 4-bit multi-bit data in four separate memory cells in an SLC mode. As the size of the multi-bit data programmed in a one-shot manner increases, or as the number of dies and/or memory blocks in which multi-bit data are programmed simultaneously increases, this approach may require a sufficiently large auxiliary power capacity for backing up the multi-bit data and consumes a large number of SLC cells.

Accordingly, in an embodiment, the multi-bit data (e.g., 4-bit data) programmed in the backup-target memory cells may be converted into 1-bit backup data based on the threshold voltage distributions PV corresponding to the multi-bit data of the backup-target memory cells.

As an illustrative example with reference to FIG. 2, for the backup-target memory cells whose programmed multi-bit data correspond to first threshold voltage distribution information PV0, PV2, PV4, PV6, PV8, PV10, PV12, PV14, the multi-bit data of these first backup-target memory cells may be converted into 1- bit backup data having a first value, for example, a logic low (0).

For the backup-target memory cells whose programmed multi-bit data correspond to second threshold voltage distribution information PV1, PV3, PV5, PV7, PV9, PV11, PV13, PV15, the multi-bit data of these second backup-target memory cells may be converted into 1-bit backup data having a second value, for example, a logic high (1).

Accordingly, during the backup operation triggered by the SPO event, each backup-target memory cell may be backed up as a 1-bit value rather than the 4-bit value.

Referring again to FIG. 6, each of the first and second open memory blocks OBLK1 and OBLK2 may include nine backup-target memory cells. The memory controller 100 may convert the 4-bit data stored in each of the backup-target memory cells of the first open memory block OBLK1 into 1-bit backup data having the first value (0) or the second value (1), based on the corresponding threshold voltage distribution. Similarly, the memory controller 100 may convert the 4-bit data stored in each of the backup-target memory cells of the second open memory block OBLK2 into 1-bit backup data the first value (0) or the second value (1), based on the corresponding threshold voltage distribution.

As shown in FIG. 6, because each of the first and second open memory blocks OBLK1 and OBLK2 includes the nine backup-target memory cells, the memory controller 100 may generate a total of 18 bits of backup data. In the conventional approach, backing up multi-bit data for 18 backup-target memory cells would require a total of 72 SLC cells (4 bits × 18 cells). However, in the present embodiment, only 18 SLC cells are used, thereby reducing the number of backup cells and power consumption by 75%.

In an embodiment, the program manager 120 of the memory controller 100 may provide the control signals CTRL, the commands CMD, and the addresses ADDR to the non-volatile memory device 200 to back up the 18 bits of backup data for the first and second open memory blocks OBLK1 and OBLK2 into 18 SLC cells. The non-volatile memory device 200 may store the 18 bits of backup data into the 18 SLC cells, respectively, based on the control signals CTRL, the commands CMD, and the addresses ADDR provided from the program manager 120.

In an embodiment, the program manager 120 may group at least two bits or more of the 18 bits of backup data for the first and second open memory blocks OBLK1 and OBLK2 to generate multi-bit backup data. For example, the 18 bits of backup data may be grouped in units of 2 bits, to generate nine-MLC backup data. Alternately, the 18 bits of backup data may be grouped in units of 3 bits to generate six-TLC backup data. Further, the 18 bits of backup data may be grouped in units of 4 bits with the remaining 2 bits grouped separately, to generate four-QLC backup data and one-MLC backup data.

As described above, by grouping the backup data and reducing the number of backup data units to be stored, the number of backup cells may be reduced or minimized.

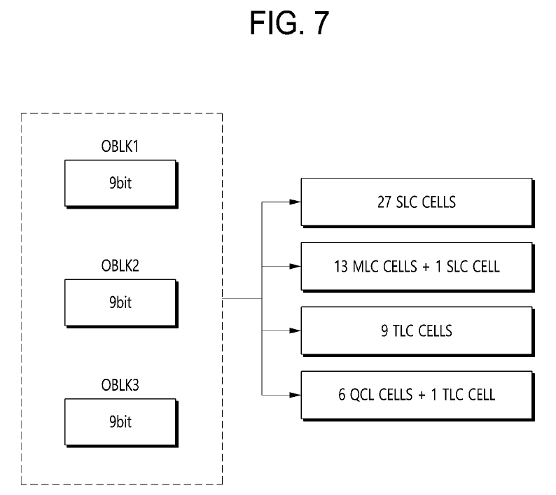

FIG. 7 is a conceptual diagram illustrating various grouping schemes for a plurality of 1-bit backup data respectively corresponding to backup-target memory cells of a plurality of open memory blocks, in accordance with an embodiment.

Referring to FIG. 7, when the backup data for each of three open memory blocks OBLK1, OBLK2, and OBLK3 is 9 bits, the total amount of backup data for all three open memory blocks may be 27 bits. For example, the number of backup-target memory cells included in the three open memory blocks OBLK1, OBLK2, and OBLK3 may be the same as the number of bits of the backup data.

As shown in FIG. 7, the 27 bits of backup data may be stored without grouping in 27 SLC cells. Alternately, the 27 bits of backup data may be grouped into a combination of 13 MLC cells of backup data and 1 SLC cell of backup data. The 27 bits of backup data may be grouped into 9 TLC cells of backup data, or grouped into a combination of 6 QLC cells of backup data and 1 TLC cell of backup data.

For example, when the 27 bits of backup data are stored without grouping, 27 SLC cells may be used to program the backup data. When the backup data are grouped into 13 MLC cells of backup data and 1 SLC cell of backup data, 13 MLC cells and 1 SLC cell may be used to program the backup data. When the backup data are grouped into 9 TLC cells of backup data, 9 TLC cells may be used. When the backup data are grouped into 6 QLC cells of backup data and 1 TLC cell of backup data, 6 QLC cells and 1 TLC cell may be used to program the backup data.

The numbers of cells used in the aforementioned backup schemes may be 27, 14, 9, and 7, respectively, and various other grouping schemes may also be employed to reduce or minimize the number of cells used for backup.

The backup data stored in the non-volatile memory device 200 in this manner may be used to restore the multi-bit data stored in the foggy-programmed memory cells once power is recovered following the SPO event. For example, based on the backup data, multi-bit data may be read from the foggy-programmed memory cells. Even when there are overlap regions among the threshold voltage distributions of the foggy-programmed memory cells, the read operation may distinguish which threshold voltage distribution a given threshold voltage belongs to by using the backup data, thereby enabling recovery of the multi-bit data.

Furthermore, the memory system 10 may perform fine-program operations on the foggy-programmed memory cells based on the recovered multi-bit data, thereby completing the program operation for the memory cells.

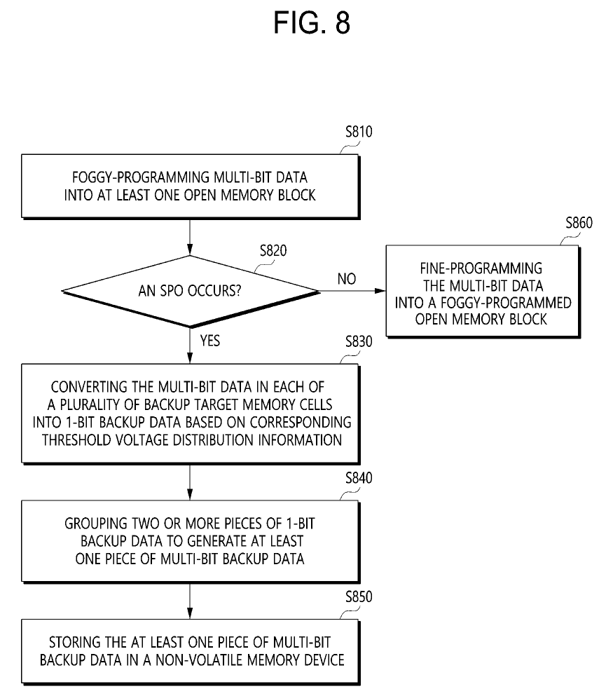

FIG. 8 is a flowchart illustrating a method of operating a memory system in accordance with an embodiment. In describing the method of operating the memory system with reference to FIG. 8, at least one of FIGS. 1 through 7 may also be referred to, and repeated descriptions of the same content as in FIGS. 1 through 7 is omitted for conciseness.

For the memory system 10, for example, the memory controller 100 may foggy-program S810 multi-bit data into at least one open memory block of the non-volatile memory device 200.

For the memory system 10, for example, the memory controller 100 may determine S820 whether an SPO event has occurred. If it is determined that an SPO event has occurred (Yes), the process may proceed to converting at S830. If it is determined that no SPO event has occurred (No), the process may proceed to fine-programming at S860.

For the memory system 10, for example, the memory controller 100 may convert S830 the multi-bit data stored in each of a plurality of backup-target memory cells included in the foggy-programmed open memory block into 1-bit backup data based on corresponding threshold voltage distribution information. For example, the multi-bit data (e.g., 4-bit data) stored in each backup-target memory cell may be converted into 1-bit backup data having a value of “0” or “1” based on its corresponding threshold voltage distribution.

For the memory system 10, for example, the memory controller 100 may group S840 two or more pieces of 1-bit backup data corresponding to the backup-target memory cells to generate at least one piece of multi-bit backup data. For example, the multi-bit backup data may include 2-bit MLC backup data, 3-bit TLC backup data, 4-bit QLC backup data, or combinations thereof.

For the memory system 10, for example, the memory controller 100 may store S850 the at least one piece of multi-bit backup data in the non-volatile memory device 200.

If it is determined at S820 that no SPO event has occurred (No), the memory controller 100 may fine-program S860 the multi-bit data into the foggy-programmed open memory block.

While the present teachings have been described in detail with reference to presented embodiments, the present teachings are not limited to the presented embodiments. Various modifications and variations can be made by those skilled in the art without departing from the scope of the technical spirit of the present teachings.

What is claimed is:

1. A method of operating a memory system, the method comprising:
foggy-programming multi-bit data into at least one open memory block included in a non-volatile memory device;
converting backup-target multi-bit data stored in a plurality of backup-target memory cells included in the at least one open memory block into 1-bit backup data based on corresponding threshold voltage distribution information, when a sudden power-off (SPO) event occurs;
grouping at least two pieces of the 1-bit backup data to generate at least one piece of multi-bit backup data; and
storing the at least one piece of the multi-bit backup data in the non-volatile memory device.

2. The method of claim 1, wherein the threshold voltage distribution information comprises:
first threshold voltage distribution information including a plurality of even-numbered threshold voltage distributions; and
second threshold voltage distribution information including a plurality of odd-numbered threshold voltage distributions.

3. The method of claim 2, wherein converting the backup-target multi-bit data into 1-bit backup data based on corresponding threshold voltage distribution information comprises:
converting the backup-target multi-bit data into 1-bit backup data having a first value when the threshold voltage distribution corresponding to the backup-target multi-bit data is included in the first threshold voltage distribution information; and
converting the backup-target multi-bit data into 1-bit backup data having a second value different from the first value when the threshold voltage distribution corresponding to the backup-target multi-bit data is included in the second threshold voltage distribution information.

4. The method of claim 3, wherein the first value is “0” and the second value is “1.”

5. The method of claim 1, wherein at least one piece of multi-bit backup data includes at least one of 2-bit backup data, 3-bit backup data, and 4-bit backup data.

6. The method of claim 1, further comprising, when power is restored following the SPO event, reading and restoring foggy-programmed multi-bit data in the at least one open memory block using the at least one piece of the multi-bit backup data stored in the non-volatile memory device.

7. The method of claim 6, further comprising fine-programming the restored multi-bit data into the at least one open memory block.

8. A memory system comprising:
a non-volatile memory device including at least one open memory block; and
a memory controller configured to:
foggy-program multi-bit data into the at least one open memory block in response to a request from a host,
convert backup-target multi-bit data stored in a plurality of backup-target memory cells included in the at least one open memory block into 1-bit backup data based on corresponding threshold voltage distribution information when a sudden power-off (SPO) event occurs, group at least two pieces of the 1-bit backup data to generate at least one piece of multi-bit backup data, and
store the at least one piece of multi-bit backup data in the non-volatile memory device.

9. The memory system of claim 8, wherein the threshold voltage distribution information comprises:
first threshold voltage distribution information including a plurality of even-numbered threshold voltage distributions; and
second threshold voltage distribution information including a plurality of odd-numbered threshold voltage distributions.

10. The memory system of claim 9, wherein the memory controller is configured to:
convert the backup-target multi-bit data into 1-bit backup data having a first value, when a threshold voltage distribution corresponding to the backup-target multi-bit data is included in the first threshold voltage distribution information; and
convert the backup-target multi-bit data into 1-bit backup data having a second value different from the first value, when a threshold voltage distribution corresponding to the backup-target multi-bit data is included in the second threshold voltage distribution information.

11. The memory system of claim 10, wherein the first value is “0” and the second value is “1.”

12. The memory system of claim 8, wherein the at least one piece of the multi-bit backup data includes at least one of 2-bit backup data, 3-bit backup data, and 4-bit backup data.

13. The memory system of claim 8, wherein the memory controller is configured to read and restore, when power is restored following the SPO event, foggy-programmed multi-bit data in the at least one open memory block using the at least one piece of the multi-bit backup data stored in the non-volatile memory device.

14. The memory system of claim 9, wherein the memory controller is configured to fine-program the restored multi-bit data into the at least one open memory block.
